(19) United States
(12) Patent Application Publication
(10) Pub. No.: US 2021/0126420 A1
(43) Pub. Date: Apr. 29, 2021

(54) THERMO-OPTIC INTRACAVITY BEAM SHAPING AND MODE CONTROL WITH DOPED OPTICAL MATERIALS

(71) Applicant: CSIR, Brummeria (ZA)

(72) Inventors: Hencharl STRAUSS, Pretoria (ZA); Darryl NAIDOO, Pretoria (ZA)

(21) Appl. No.: 17/255,252

(22) PCT Filed: Jun. 26, 2019
(86) PCT No.: PCT/IB2019/055371

§ 371 Date: Dec. 22, 2020

(30) Foreign Application Priority Data
Jun. 27, 2018 (ZA) 2018/04307

(51) Int. Cl. H01S 3/08; H01S 3/106; H01S 3/0941; H01S 3/102

(52) U.S. Cl. CPC H01S 3/08077; H01S 3/1028; H01S 3/09415; H01S 3/1061

(57) ABSTRACT

A laser beam shaping system which has a laser resonator configured to operate at a resonating, first wavelength range to produce an intracavity resonating beam and a laser gain material, configured to produce gain and to amplify the first wavelength range within the laser resonator. The system has at least one doped medium, which is optically transparent at the first wavelength range, which is doped with a dopant, and which is provided intracavity in the laser resonator and at least one absorbed beam input or coupling configured to generate or receive at least one absorbed beam at a second wavelength range which is different from the first wavelength range and which is directed towards the doped medium. The doped medium has a higher absorption characteristic at the second wavelength range than at the first wavelength range, causing the absorbed beam to have a higher absorption than the resonating beam in the doped medium, but which does not provide gain in the first wavelength range. Optical surfaces of the doped medium are coated to be anti-reflective at the first wavelength range and highly transmissive at the second wavelength range.

### FIELD OF INVENTION

This invention relates broadly to optics and to thermal characteristics of optical elements, and specifically to controlling the beam-shape, mode content and divergence of laser resonators using thermo-optical characteristics in non-gain, bulk, doped optical materials.

### BACKGROUND OF INVENTION

Laser resonators using bulk optical gain materials are often designed to operate optimally only in a range of outpowers close to the maximum output power. Such gain materials may have strong thermal lensing characteristics and examples include Nd:YVO₄ and Nd:YAG etc. Thermal lensing inside the gain material may result in variation of beam parameters such as beam quality (Beam Parameter Product—BPP), divergence and beam shape as the power output of the laser is changed. It may be necessary to adjust the physical length of the resonator and/or placement and/or curvature of the cavity optics to adjust the output beam parameters.

Another way to approach this is that laser beam parameters (such as beam shape, beam power and BPP) that are exhibited at a specific output power are mostly fixed. The optimum beam parameters are therefore not available over the entire range of output powers available from laser resonators with gain material that have strong thermal lensing and external attenuation has to be used to vary the power to the required level, which leads to inefficient operation. In addition, some laser beam shapes and transformations cannot be generated by conventional spherical shaped optics. This can be accomplished by static, specially shaped, optics such as free-form optics or diffractive optical elements (DOEs) (https://www.spiedigitallibrary.org/conference-proceedings-of-spie/10036/100360V/Improving-the-laser-brightness-of-a-commercial-laser-system/10.117/12.2244293.full?SSO=1). These elements can handle very high intracavity laser powers, but they need to be specially designed and manufactured for a specific cavity and transformation. They are expensive, have long manufacturing lead times, are designed to transform fixed beam shapes and sizes and cannot be adjusted once manufactured. They are also sensitive to alignment and other variables such as pump power dependant phase distortions in the gain material.

Recent attempts have been made to actively control the beam parameters by using a dynamic beam shaping element such as a spatial light modulator or microelectromechanical mirrors (MEMS) instead of cavity mirrors (https://www.nature.com/articles/ncomms3289.pdf?origin=ppub). These systems have been shown to enable laser resonators to generate a wide variety of laser beams; however, these elements can only handle limited intracavity powers, which restricts their usefulness.

Recently, controlling the gain profile inside the laser gain material has been shown to give active control over the output laser beam shape at potentially high powers (https://link.springer.com/article/10.1007/s00340-017-6747-2). While such systems have many benefits such rapid transformations rates, they might not be cost effective at high output powers, which is required for many applications.

Here the Applicant proposes a method to control some or all of the following aspects of output beam of laser resonator cavity:
Spatial profile (shape)
Divergence
BPP
Brightness

The Applicant wishes to use an extra element or elements intracavity to the laser resonator that are relatively cheap, are easily adjustable and have no inherent power damage limits.

The Applicant wishes to use the broader concept of thermo-optic phase change profiles, of which thermal lensing is but one example, in an intentional manner to transform, control or realise a thermo-optic phase transformation profile inside a special doped and coated medium/media to transform or shape the beam inside a laser cavity or to adjust the number of Gaussian modes inside a laser cavity.

### SUMMARY OF INVENTION

Accordingly, the invention provides a laser beam shaping system which includes:
a laser resonator configured to operate at a resonating, first wavelength range to produce an intracavity resonating beam;
a laser gain material, configured to produce gain and to amplify the first wavelength range within the laser resonator;
at least one optically transparent medium, at the first wavelength range, which is doped with a dopant (hereafter referred to as the doped medium) which is added intracavity to the laser resonator;
at least one absorbed beam input or coupling configured to generate or receive at least one absorbed beam at a second wavelength range which is different from the first wavelength range and which is directed towards the doped medium,
wherein the doped medium has a higher absorption characteristic at the second wavelength range than at the first wavelength range, causing the absorbed beam to have a higher absorption than the resonating beam in the doped medium but also does not provide any gain to beams in the first wavelength range,
and wherein the doped medium's optical surfaces are coated to be anti-reflective at the first wavelength range and highly transmissive at the absorbed wavelength range.

The doped medium may have at least one set, and optionally two sets, of orthogonally placed cooling surfaces with independently variable and controllable temperatures.

Two sets of orthogonally placed cooling surfaces of the doped medium may have specifically designed/calculated temperatures such that vertical and horizontal tilts can be controlled in order to keep the resonator cavity aligned during the modifying process caused by the absorbed beam input(s).

The absorbed beam input may have specifically designed/calculated beam profiles/shapes sizes and positions to cause a specific transformation via a thermo-optical phase change profile of the phase of the resonating beam at the first wavelength, thereby modifying the output of the resonator at the first wavelength range.

The laser resonator may be a high average power laser in the order of watts, kilowatts or more, such as from high power bulk solid state lasers, CO₂ lasers etc. The laser resonator may have >1 W average output.

Alternatively, the laser resonator may be a high peak power laser such as Q-switched, mode-locked or femto-second lasers etc., e.g., having >1 kW peak output.

Alternatively, the laser resonator may be a high energy laser such as Q-switched, mode-locked, gain-switched, cavity-dumped, laser, etc., e.g., having a >1 mJ output.

The resonating beam output may be used in laser material processing applications like additive manufacturing, laser cladding, laser welding, laser cutting etc., for directed energy applications as well as for high power communications and lidar applications etc.

The absorbed beam input may be from one or more low cost lasers that are able to deliver variable average powers, such as diode lasers, delivery fibre-coupled diode lasers or other homogenised diode lasers.

The absorbed beam input(s) may be provided parallel to the resonating beam. The absorbed beam input(s) may also be provided with an angular offset (i.e., not parallel) to resonating beam.

The laser system may include a beam guiding component to guide the resonating beam and/or the absorbed beam input. The beam guiding component may be a dichroic mirror or beam-splitter. The beam guiding component can either be additionally added internal or external to the laser cavity or be one of the laser cavity mirrors.

The absorption of at least one of the absorbed beams is converted to heat and will cause a temperature gradient within the doped medium. The temperature profile inside the material induces a refractive index profile variation whose magnitude is primarily dependent on the thermo-optical coefficient or coefficients (dn/dT) of the material. This may result in the formation of an optical phase change profile within the doped medium.

In general the thermo-optical phase change profile inside the non-gain doped medium or media may modify or transform the resonating beam. The term “modify” the resonating beam implies transforming its phase through a thermo-optically induced phase change profile within it. This may result in changing, transforming or compensating the intracavity resonating beam in a controlled manner. This is different from the mostly unwanted side effect of thermal lensing inside bulk laser gain materials in which such a phase transformation (thermal lensing) is coupled to the gain.

The additional, but controlled, thermal phase change profile inside the laser cavity control or shape a number of parameters of the output laser beam by either controlling the modes inside a laser resonator, or by non-quadratically changing the phase inside the laser resonator.

The type or extent of the thermo-optical phase change profile in a doped optical medium, induced by the absorbed beam(s), may depend on:
absolute intensity of the absorbed beam(s) and the transmitted resonating beam;
relative intensity of the absorbed beam(s) and the transmitted resonating beam;
cooling/heating arrangement of the doped optical medium;
relative size of the absorbed beam(s) and the transmitted resonating beam to each other and relative to the cooling surfaces of the doped optical medium;
position of the absorbed and transmitted resonating beams relative to each other and relative to the cooling surfaces of the doped optical medium;
intensity profile of the absorbed beam(s);
type of doped optical medium (especially its do/dT coefficient).

The resonating beam may be higher power, even an order of magnitude or more, than the absorbed beam input. An advantage of this may be that a relatively low power, low cost absorbed beam input (such as from diode lasers) may be used to shape the beam output of a relatively high-power laser resonator.

The medium may be a crystalline medium or a glass.

The doped medium may have a positive thermo-optical coefficient or coefficients (dn/dT). Such a doped medium may be doped silicate glass, Vanadate (VO₄) or Yttrium Aluminium Garnet (YAG) etc.

The doped medium may have a negative thermo-optical coefficient or coefficients (dn/dT). Such a doped medium may comprise doped Yttrium Lithium Flouride (YLF) or Calcium Flouride (CaF₂), etc.

Both types of media may be doped with Nd, Yb, Tm, Er, etc. referred to as the dopant. The function of the dopant is to selectively absorb only the absorbed beams in a selected wavelength range and to convert this wavelength range to heat (not gain of the first wavelength).

Optical materials commonly used as base materials for laser gain materials (e.g., a crystalline or glass gain mediums) may be used as the medium.

It will be noted that in the present configuration, the doped medium may not significantly contribute to gain at the first wavelength range of the resonating beam. While the dopants listed as examples are traditionally used as gain media, they do not necessarily fulfil this function for this present invention. The dopant may be merely to assist absorption of the absorbed beam(s) with a resultant controlled heated zone within an optical material(s) that is transparent to the first wavelength range of the transmitted resonating beam. For example, the transmitted resonating beam (as a result of an influence of the heated optical medium acting on the resonating beam input) may have a wavelength range in the region of 1 μm and the absorbed beam input may have a wavelength range of 792 nm. The dopant may be Th (thulium) (which is commonly used to achieve gain near 1.9 μm). Materials which are not traditional laser gain dopants may also be used.

The doped medium may not amplify or absorb the resonating beam input. This may mean that 99.9%, alternatively, 99%, alternatively 95%, and alternatively 90%, of the transmitted resonating beam is not amplified or absorbed. However, at least one absorbed beam input is, at least partially, absorbed.

It will be noted that in the present configuration, an undoped medium may not significantly absorb the first or second wavelength ranges of the resonating or absorbed beams. This may mean that 99.9%, alternatively, 99%, alternatively 95% of the resonating or absorbed beam(s) is not absorbed in an undoped medium.

To reduce losses, the doped medium may be coated with a layer of material that causes the doped medium to be Anti-Reflective (AR) for which the reflective losses may be reduced primarily for the resonating beam wavelength range, and to a lesser extend for the absorbed beam wavelength range. This may mean that 99.9%, alternatively, 99%, alternatively 95%, and alternatively 90%, of the resonating and absorbed beam(s) are not reflected by the surfaces of the doped medium(s).

The doped medium may also be uncoated, but Brewster cut, to reduce losses to polarised resonating beams.

If the rate of change of phase transformation is important, then a doped medium/media having high thermal conductivity may be selected.

An efficient and effective doped medium may have the following properties:
High optical transmission and very little absorption and no gain of the resonating beam;
Controllable absorption of the absorbed beam via the doping concentration;
A high percentage of conversion of the absorbed beam optical energy to thermal energy;
A high thermal conductivity;
Low reflective losses of the resonating and absorbed beams;
High damage thresholds to accommodate very high power/energy resonating beams and
A high thermo-optical coefficient(s) (dn/dT).

All of these properties together may define a class of optical material (thermo-optical shaping materials) which is different from conventional laser gain materials. Such materials need to be specially manufactured and correctly coated ones are not yet commercially available as stock items.

One example of this invention is to control or change the number of modes inside the cavity. When a single flat-top shape absorbed beam is used, the phase change profile is quadratic and acts like a variable lens for resonating beams smaller than the extent of the flat-top absorbed beam. The resonator stability can then be varied and the number of modes inside the cavity can be controlled, similarly to changing the curvature of one of the cavity mirrors, or inserting a set of lenses into the cavity. This can result in control of the beam outputs such as the BPP, beam profile and divergence, all by manipulating the number of modes that resonate within the cavity. Note that the beam profiles in stable cavities will be linear combinations of rectangular (Herm ite), circular (Laguerre) symmetric laser modes or other orthogonal mode sets.

Spherical aberrations in the thermal lens inside the gain material lead to significant losses in low BPP (M² near to 1) designed lasers. This leads to lower brightness output. To compensate for this, a doped medium is added in series in the cavity with opposite do/dT from that found in the gain material. A spherically aberrated lens inside the doped medium then compensates for the aberrations (both spherical and quadratic inside the gain material.

For internal beam transformations to increase the brightness such as shown in [https://patents.google.com/patent/US9031113B2/en], two doped optical elements are used with the transformation specified in that patent. Since this patent uses two transforming elements inside the cavity it is very sensitive to alignment, thermally induced phase aberrations and manufacturing errors. Variable phase transforming elements, such as the doped media described here, might therefore enable a practical implementation of this patent.

The laser resonator system may include a controller configured to control the absorbed beam input(s), thereby to control the absorbed beam(s) and/or individual cooling elements. Alternatively, or in addition, the laser system may include a lookup table of pre-set values of power levels of the absorbed beam(s) inputs, thereby to control the absorbed beam(s) and/or individual cooling elements. To the extent that the thermo-optical phase change profile is dependent on the absorbed beam(s), the thermo-optical phase change profile may be adjusted or controlled by adjusting or controlling the absorbed beam(s).

### BRIEF DESCRIPTION OF DRAWINGS

The invention will now be further described, by way of example, with reference to the accompanying diagrammatic drawings.

In the drawings:

FIG. 1 shows a schematic side view of a first embodiment of a laser system in accordance with the invention;

FIG. 2 shows a schematic front view of an example absorbed beam configuration of the laser system of FIG. 1;

FIG. 3 shows a schematic three-dimensional view of part of a second embodiment of a laser system in accordance with the invention including only a doped medium and absorption beams;

FIG. 4 shows a schematic front view of an example absorbed beam configuration of the laser system of FIG. 3;

FIG. 5 illustrates a control system which may form part of the laser system of FIG. 1 or 3; and

FIG. 6 shows a schematic side view of a third embodiment of a laser system in accordance with the invention.

### DETAILED DESCRIPTION OF EXAMPLE EMBODIMENT

The following description of the invention is provided as an enabling teaching of the invention. Those skilled in the relevant art will recognise that many changes can be made to the embodiment described, while still attaining the beneficial results of the present invention. It will also be apparent that some of the desired benefits of the present invention can be attained by selecting some of the features of the present invention without utilising other features. Accordingly, those skilled in the art will recognise that modifications and adaptations to the present invention are possible and can even be desirable in certain circumstances, and are a part of the present invention. Thus, the following description is provided as illustrative of the principles of the present invention and not a limitation thereof.

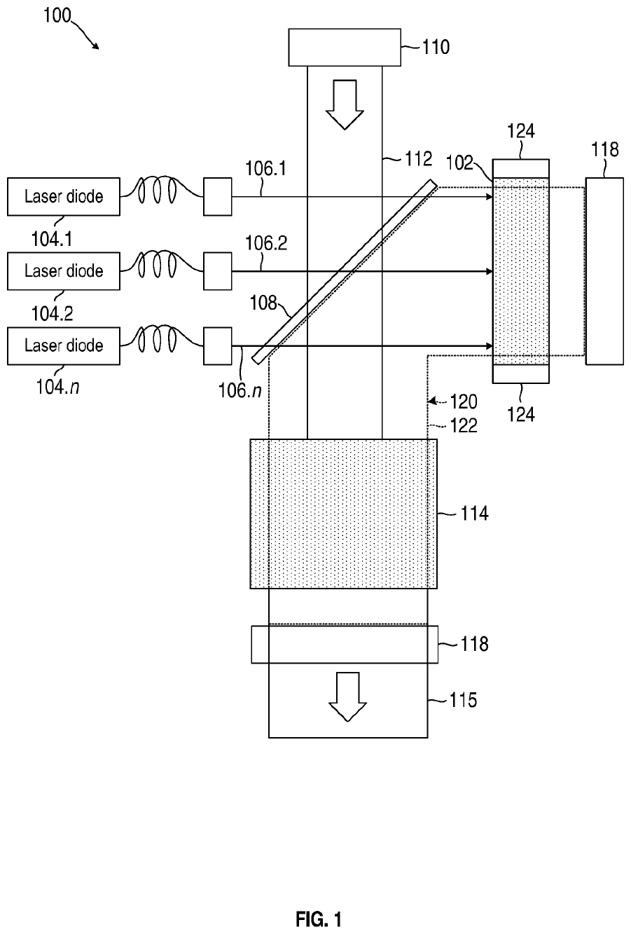

FIG. 1 illustrates a first embodiment of a laser system 100 in accordance with the invention. The laser system 100 comprises two resonating end mirrors 118 which define a laser resonator 120 there between. The laser resonator 120 is configured to resonate at a first wavelength range. One of the end mirrors is fully reflective and the other partially reflective at the first wavelength range.

The laser system 100 has a pump input 110 configured to generate a pump beam 112 at a third wavelength range different from the first wavelength range. The laser system 100 has two types of doped optically transparent media 102, 114 which are doped with different dopants provided within the laser resonator 120. The first doped medium 114 is to provide gain to the laser cavity 120 (hence referred to as the gain medium 114). It absorbs energy from a pump source (in the third wavelength range) in order to provide gain to the laser resonator 120. This can either be longitudinally/end pumped (as illustrated) or from transverse/side pumped (not illustrated). In some embodiments the gain material can also be pumped by non-optical means such as electrical or chemical pumping. In this example, the doped gain medium 114 is a standard Nd:YAG crystal coated to be end-pumped at the third wavelength range near 808 nm. It is coated to be anti-reflective at 1 μm and highly transmissive at 808 nm.

The second doped medium 102 is to provide variable and controllable thermo-optical phase change profiles to the laser resonator 120. The second doped medium 102 absorbs light at a second wavelength range which is different from the first wavelength range. The second doped medium 102 itself is a bulk crystalline or glass medium but which is not operated as a gain medium in other cases (in accordance with prior art techniques), the same type of crystalline medium could be utilised as a gain medium in a conventional laser amplifier, with different anti-reflective coatings at wavelength ranges other than first wavelength range. The second doped medium 102 is optically transparent at the first wavelength range. This is the wavelength range that is amplified inside the first doped medium 114 and which is resonant within the laser resonator 120. In this example, the first wavelength is near 1 μm. The second doped medium 102 is at least partially optically absorptive at the second wavelength near 792 nm. In this example, the absorptive properties are due to the presence of the dopant Thulium in the second doped medium 102.

The laser system 100 has a plurality of absorbed beam inputs 104.1, 104.2, 104.n (referred to collectively by numeral 104). The absorbed beam inputs 104 are configured to generate respective absorbed beams 106.1, 106.2, 106.n (referred to collectively by reference numeral 106) at the second wavelength. In this example, the absorbed beam inputs 104 are fibre coupled laser diodes, which are relatively cheap, compact, and readily available. In this example, a laser beam generated by such laser diodes 104 has a wavelength near 792 nm.

The various absorbed beams 106 are parallel to one another. The laser system 100 has a beam guiding component 108 in the form of a dichroic mirror. 108 is arranged diagonally at 45° between the absorbed beams 106 and both doped media 114, 102. The beam guiding component 108 transmits both the pump (at the third wavelength range) 112 and absorbed beams (at the second wavelength range) 106 (transmits 95 to 99.9%) and reflects a resonating beam (at the first wavelength range) 122 (by more than 99.9%).

In this example, the second doped medium 102 is coated with a layer of material that is Anti Reflective (AR) at resonating wavelength ranges near 1 μm and Highly Transmissive (HT) at absorbed wavelength ranges near 792 nm.

The second doped medium 102 may also have one surface that is coated highly reflective at the resonating wavelength range. In such cases the face that is thus coated acts as one of the resonating end mirrors (118) of the laser resonator 120.

Importantly, at least some optical energy from the absorbed beams 106 is absorbed by the second doped medium 102 and converted to heat. This causes the second doped medium 102 to heat up in the region of the absorbed beams 106 and thereby induces a thermo-optical phase change profile.

The precise type of thermo-optical phase change profile may vary depending on a number of factors, including the substance of the medium, the dopant, the absorbed beam(s) 106, the resonating beam 122, the relative arrangement of the absorbed beams 106, cooling configuration of the medium, etc.

The thermo-optical phase change profile acts as a variable phase element within the cavity. The effect can either be to act as a variable lens or as a variable beam transforming element. A profile of an output beam 115 is thus controllable.

Heating or cooling elements 124 and 125 may be provided at or near the doped medium 102 (e.g., at sides of the doped medium 102) to provide additional heating or cooling characteristics. Applying a controllable temperature difference on two opposite placed elements causes a tilt thermo optical phase change aberration. This can be used to compensate for any unwanted tilt aberrations caused by the second absorptive beams (104), keeping the resonator aligned.

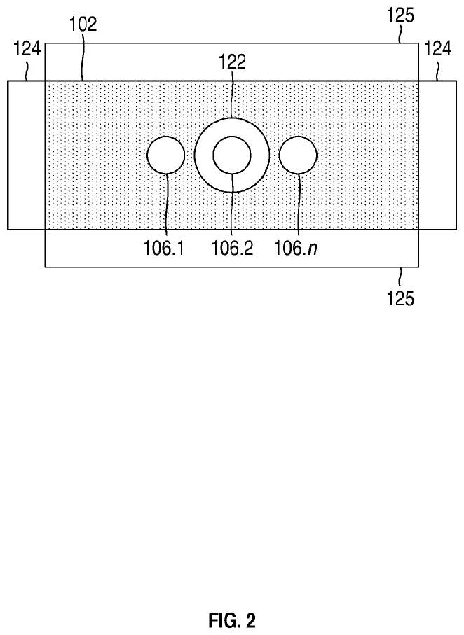

FIG. 2 illustrates an input beam configuration of the absorbed beams 106 and the resonating beam 122 provided by the laser system 100 (with four orthogonally placed heating or cooling elements 124, 125). In this example, the resonating beam 122 is arranged centrally and the absorbed beams 106 are arranged linearly. The absorbed beams in this example have a uniform circular (top hat) intensity profile.

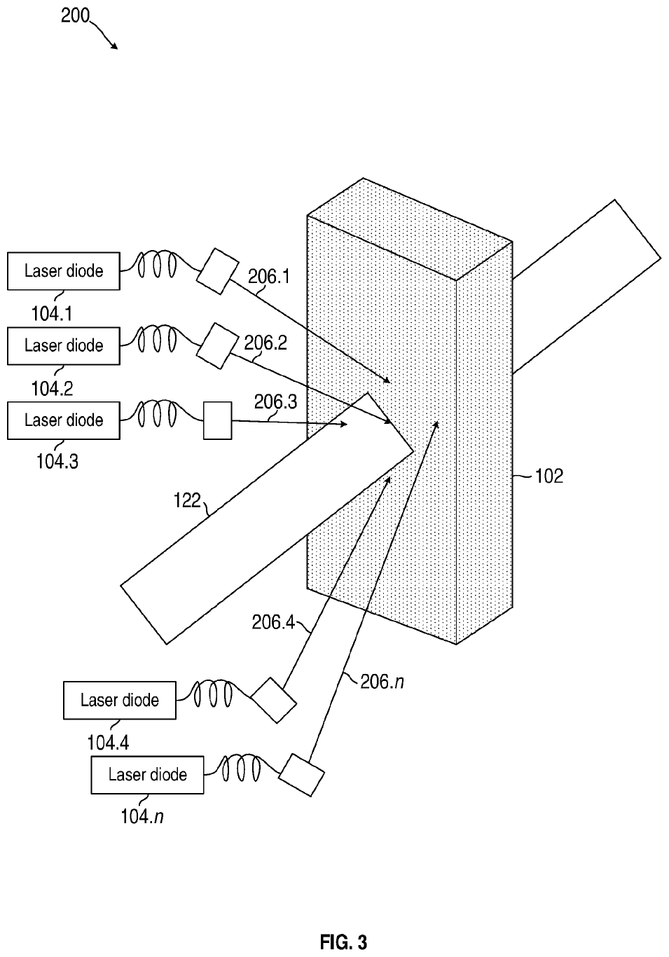

FIG. 3 illustrates a second embodiment of part of a laser system 200 in accordance with the invention, showing only the doped medium and absorption beams (without the heating or cooling elements). The same numerals in different FIGS refer to the same or similar features. The laser system 200 has laser diodes 104 but instead of providing parallel absorbed beams, they provide converging absorbed beams 206 and thus dispense with the need for the dichroic mirror 108 of the laser system 100 of FIG. 1. Here the resonating beam 122 is transformed by the doped medium 102.

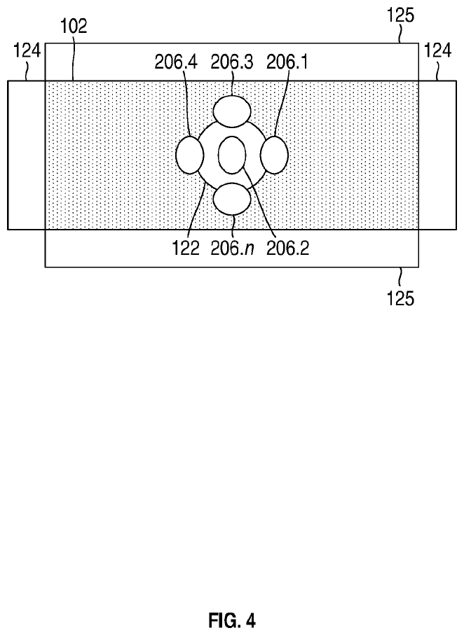

FIG. 4 illustrates the arrangement of beams 206 provided by the laser system 200. In this case, the flat-top shaped absorbed beams 206 are arranged in a cross. It will be appreciated that FIGS. 2 and 4 illustrate but two of a large number of potential input beam arrangements, which may vary considerably based on design requirements and preferences.

An advantage of the laser system 100, 200 is that relatively lower power absorbed beam(s) can be used to control a relatively higher power resonating beam.

An advantage is that the magnitude and distribution of the phase change profile can be changed by changing the amount of optical energy in the absorbed beam(s) (from the laser diodes 104. The result is the ability to easily vary the effect and/or the 3o magnitude of the phase change element(s).

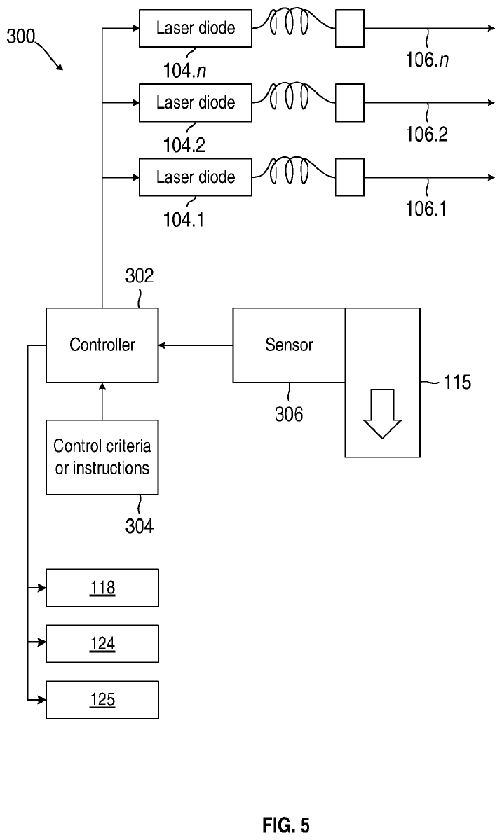

Another advantage may be that the laser diodes 104 are easily electronically controllable. FIG. 5 illustrates a basic control system 300 which may form part of the laser system 100, 200. An electronic controller 302 can control the laser diode 104 to vary characteristics of the absorbed beams 106, e.g., their intensity. The controller 302 comprises control criteria or instructions 304 and may be embodied by a computer. Optionally, the control system 300 also includes a sensor or detector 306 to sense a characteristic of the output resonating beam 115 or any other relevant sensor, thereby enabling the controller 302 to adjust the laser diode(s) 104 according to a characteristic of the output resonating beam thus providing a feedback mechanism. This could be used to correct/control the characteristics of the output of the laser beam from the resonator 120, e.g., changing its mode content, beam shape, BPP and divergence etc. The electronic controller 302 can also control the heating or cooling elements (124, 125) or electronic tip and tilt of one of the two cavity end mirrors in order to keep the cavity aligned for different outputs of the laser diode(s) 104.

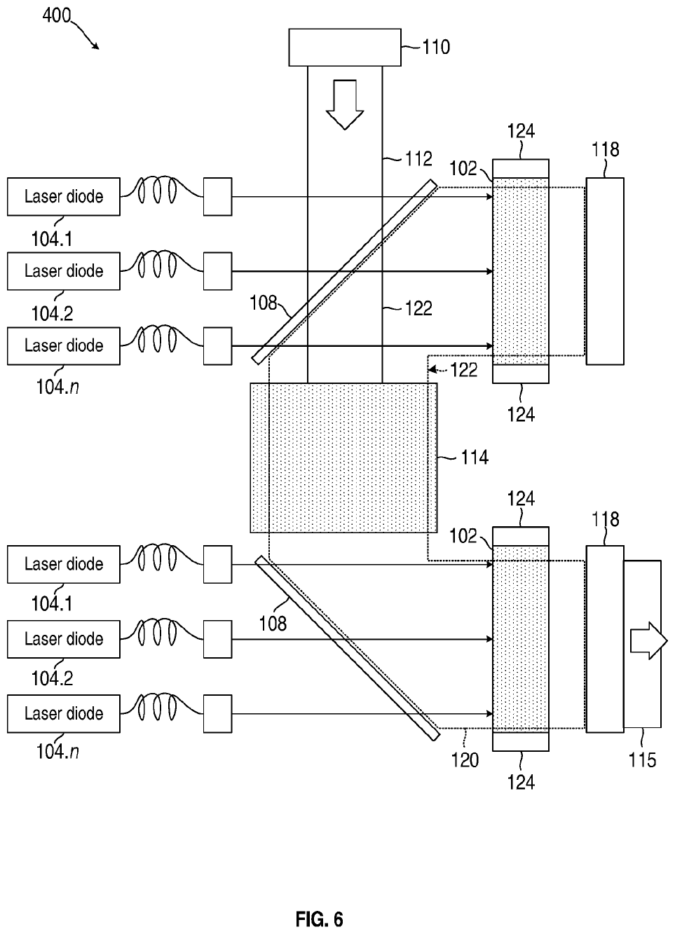

As illustrated in FIG. 6, in some embodiments, a laser system 400 may be provided with two (or more) second doped elements 102 in the laser resonator 120 or cavity. Traditionally, this has been very difficult to implement with conventional beam shaping techniques. In such cases, two or more beam directing dichroic mirrors 108 may be added to the system 400.

The Applicant envisages that the inventive principle may enable a range of new laser products. These products would enable variable BPP output, variable beam shapes and higher brightens than is currently available from bulk solid-state lasers.

These could be applied to more efficient laser material processing or high-power communications and lidar applications, etc.

What is claimed is:

1. A laser beam shaping system which includes:
a laser resonator configured to operate at a resonating, first wavelength range to produce an intracavity resonating beam;
a laser gain material, configured to produce gain and to amplify the first wavelength range within the laser resonator;
at least one doped medium, which is optically transparent at the first wavelength range, which is doped with a dopant, and which is provided intracavity in the laser resonator;
at least one absorbed beam input or coupling configured to generate or receive at least one absorbed beam at a second wavelength range which is different from the first wavelength range and which is directed towards the doped medium,
wherein the doped medium has a higher absorption characteristic at the second wavelength range than at the first wavelength range, causing the absorbed beam to have a higher absorption than the resonating beam in the doped medium, but which does not provide gain in the first wavelength range,
and wherein optical surfaces of the doped medium are coated to be anti-reflective at the first wavelength range and highly transmissive at the second wavelength range.

2. The laser beam shaping system as claimed in claim 1, wherein the absorbed beam input has at least one of a beam profile, shape, size, and/or position to cause a specific transformation via a thermo-optical phase change profile of a phase of the resonating beam at the first wavelength range, thereby modifying an output of the resonator at the first wavelength range.

3. The laser beam shaping system as claimed in claim 1, in which:
the laser resonator is a high average power laser resonator (>1W average output);
the laser resonator is a high peak power laser resonator (>1 kW output); or
the laser resonator is a high energy laser resonator (>1 mJ output).

4. The laser beam shaping system as claimed in claim 1, which is configured to be used in:
laser material processing applications; or
high power communications and lidar applications.

5. The laser beam shaping system as claimed in claim 1, in which the absorbed beam input or coupling is one or more laser diode, fibre-coupled diode laser, or other homogenised diode laser.

6. The laser beam shaping system as claimed in claim 1, which is configured to provide the absorbed beam parallel to the resonating beam.

7. The laser beam shaping system as claimed in claim 1, which is configured to provide the absorbed beam with an angular offset (i.e., not parallel) to resonating beam.

8. The laser beam shaping system as claimed in claim 1, which includes at least one beam guiding component to guide the resonating beam and/or the absorbed beam.

9. The laser beam shaping system as claimed in claim 1, in which the absorbed beam, when absorbed, is converted to heat and causes a temperature profile within the doped medium.

10. The laser beam shaping system as claimed in claim 9, in which the temperature profile inside the doped medium induces a refractive index profile variation whose magnitude is primarily dependent on a thermo-optical coefficient or coefficients (dn/dT) of the material.

11. The laser beam shaping system as claimed in claim 10, in which the refractive index profile variation results in formation of an optical phase change profile within the doped medium.

12. The laser beam shaping system as claimed in claim 11, in which the optical phase change profile inside the doped medium modifies the resonating beam.

13. The laser beam shaping system as claimed in claim 12, in which the resonating beam is modified by either controlling the modes inside a laser resonator or by non-quadratically changing the phase inside the laser resonator.

14. The laser beam shaping system as claimed in claim 11, in which the optical phase change profile within the doped medium, induced by the absorbed beam, depends one or more of:
absolute intensity of the absorbed beam and the resonating beam;
relative intensity of the absorbed beam and the resonating beam;
cooling/heating arrangement of the doped optical medium;
relative size of the absorbed beam and the resonating beam to each other and relative to the cooling surfaces of the doped optical medium;
position of the absorbed and resonating beams relative to each other and relative to the cooling surfaces of the doped optical medium;
intensity profile of the absorbed beam; and/or
type of doped optical medium.

15. The laser beam shaping system as claimed in claim 1, in which the resonating beam has higher power than the absorbed beam.

16. The laser beam shaping system as claimed in claim 1, in which the doped medium is a crystalline medium or a glass medium.

17. The laser beam shaping system as claimed in claim 16, where the function of the dopant in the doped medium is to selectively absorb only the absorbed beam in the second wavelength range and to convert at least some of the absorbed beam to heat, while providing no gain to the resonating beam at the first wavelength range.

18. The laser beam shaping system as claimed in claim 1, in which:
the doped medium is coated with an Anti-Reflective (AR) layer at the first wavelength and High Transmissive (HT) at the second wavelength.

19. The laser beam shaping system as claimed in claim 1, in which the doped medium is provided in series with the gain material in the laser resonator, the doped medium having inverse dn/dT from that found in the gain material.

20. The laser beam shaping system as claimed in claim 1, which includes a controller configured to control the absorbed beam input, thereby to control the absorbed beam.

21. (canceled)

22. The laser beam shaping system as claimed in claim 20, in which the controller is configured to control an electronic tip and tilt of at least one cavity end mirror in the laser resonator in order to keep a cavity aligned for different outputs of absorbed beams.
